(19) United States
(12) Patent Application Publication
(10) Pub. No.: US 2003/0236918 A1
(43) Pub. Date: Dec. 25, 2003

(54) System and method for producing an encapsulated multimedia packets

(76) Inventors: Eyal Manor, Yehud (IL); Hagai Sela, Sede Warburg (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/175,147

(22) Filed: Jun. 20, 2002

(51) Int. Cl. G06F 15/16

(52) U.S. Cl. 709/250

(57) ABSTRACT

The present invention includes a network layer module which may communicate with a computing device's network layer and intercept packets produced by one or more source applications running on the computing device. A protocol unwrapping unit may unwrap the intercepted packets, and a prioritization module may assign a priority value to each unwrapped packet based on the packet's source application. A synchronized data packing module may insert into an encapsulated packet at least a portion of an unwrapped packet, wherein the inserted portion of an unwrapped packet's size relative to the encapsulated packet's size is correlated to the inserted packet's relative priority value.

### FIELD OF THE INVENTION

The present invention relates generally to the field of digital communications. More specifically, the present invention relates to a system and method for producing encapsulated multimedia packets.

### BACKGROUND OF THE INVENTION

The development of the Internet and other similar distributed data communication networks has facilitated a growth in the number of people using packet based communication applications such as voice over I.P. (“VoIP”), video over I.P. (“VidIP”), chat, co-browsing, and application sharing for communicating and collaborating with one another. Applications running on two separate computers may enter into a communication session where they exchange packets over a distributed network. The packets may contain coded data representing information, in any media format.

FIG. 1 shows an example of two computing devices engaged in multiple simultaneous communications sessions over a distributed data network according to the prior art. Each computing device (e.g. a desktop computer or a mobile computer) may have multiple communication applications, such as VoIP, VidIP, chat, and application sharing, running and communicating with corresponding applications on another computing device or computer. Each application may generate its own data stream which stream may be packetized and addressed to a corresponding application on the other computing device. A stream of data representing media may be termed a media stream and the media streams may be packed and sent over the internet using UDP or RTP protocols.

Having multiple data or media, streams simultaneously exchanged between two computing devices over a distributed network presents a number of issues. As shown in FIG. 1, if one of the computers is behind a firewall, certain media streams may be blocked. For example, many firewalls will block UDP and RTP packets from passing through. Furthermore, if bandwidth on the communications link between the two computing devices is less than the cumulative data-rate at which data and media streams are being generated by applications on a computing device (e.g. in low bit rates connections, such as dialup, ISDN 64 and others), data congestion and packet collisions may occur within the computing device's network layer or on the network between the two computers.

### SUMMARY OF THE INVENTION

The present invention includes a network layer module which may communicate with a computing device's network layer and intercept packets produced by one or more source applications running on the computing device. A protocol unwrapping unit may unwrap the intercepted packets, and a prioritization module may assign a priority value to each unwrapped packet based on the packet's source application. A synchronized data packing module may insert into an encapsulated packet at least a portion of an unwrapped packet, wherein the inserted portion of an unwrapped packet's size relative to the encapsulated packet's size is correlated to the inserted packet's relative priority value.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing two computing devices exchanging multiple simultaneous media streams over a distributed network in accordance with the prior art;

FIG. 2 is a block diagram showing two computing devices exchanging multiple simultaneous media streams over a distributed network in accordance with the present invention;

FIG. 3 is a block diagram showing a computing unit with an encapsulator/decapsulator unit according to the present invention;

FIG. 4 is a block diagram showing the modules of an encapsulator/decapsulator unit according to the present invention;

FIG. 5A is a flow chart showing the steps of a method of producing an encapsulated multimedia packet according to the present invention;

FIG. 5B is a flow chart showing the steps of a method of converting an encapsulated multimedia packet back into its constituent packets;

FIG. 6A is a data flow diagram exemplifying the conversion of several packets into one or more encapsulated multimedia packets; and

FIG. 6B is a data flow diagram exemplifying the conversion of one or more encapsulated multimedia packets into their constituent packets.

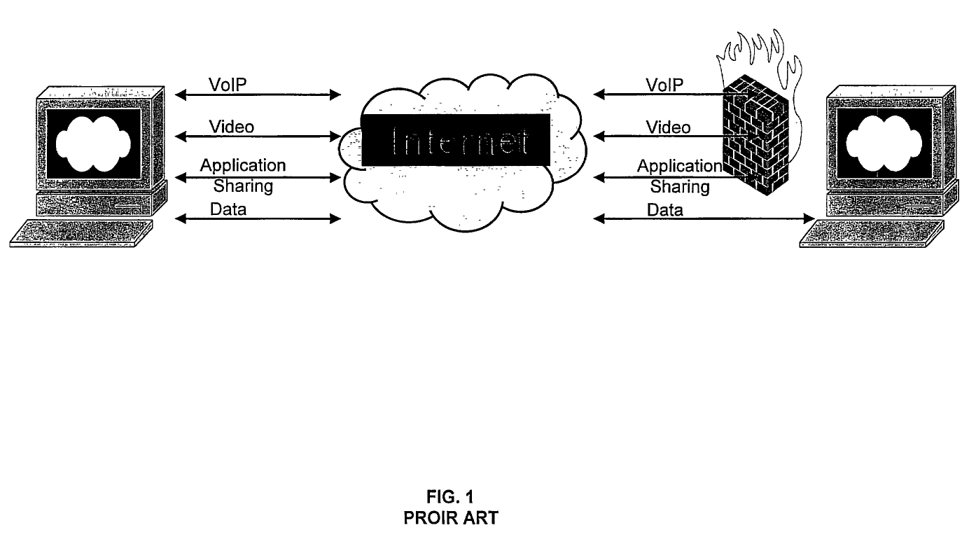

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention includes a network layer module may communicate with a computing device's network layer and intercept packets produced by one or more source applications running on the computing device. A protocol unwrapping unit may unwrap the intercepted packets, and a prioritization module may assign a priority value to each unwrapped packet based on the packet's source application. A synchronized data packing module may insert into an encapsulated packet at least a portion of an unwrapped packet, wherein the inserted portion of an unwrapped packet's size relative to the encapsulated packet's size is correlated to the inserted packet's relative priority value.

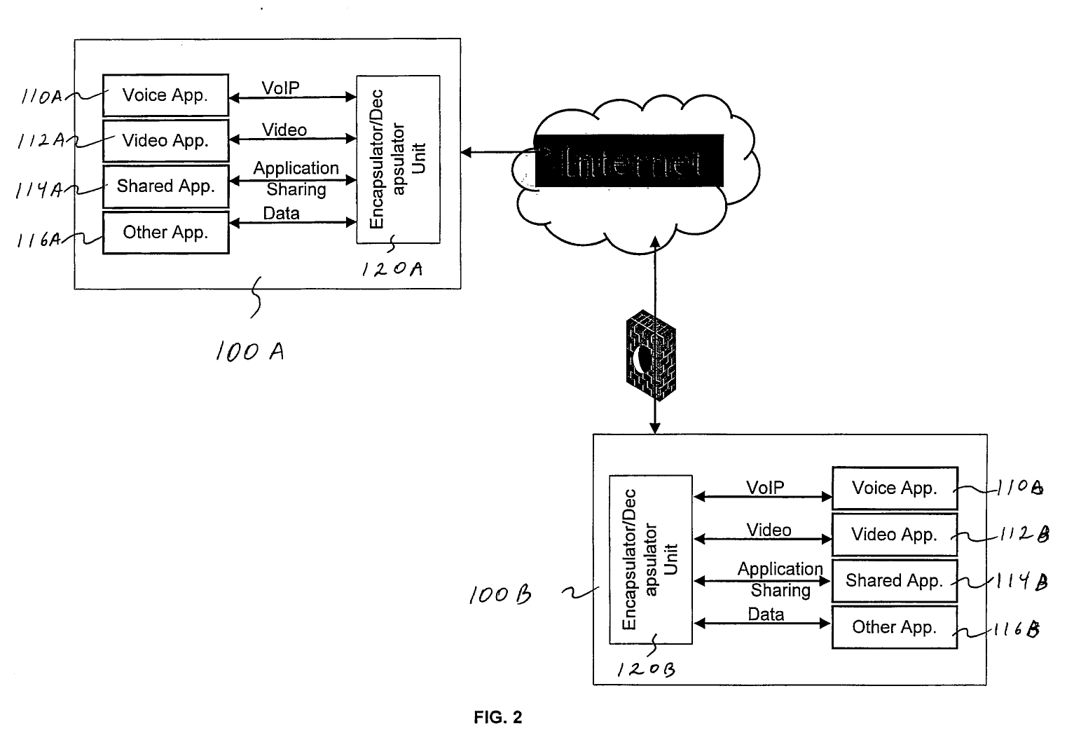

Turning now to FIG. 2, there is shown a block diagram of two computing devices exchanging multiple simultaneous media streams over a distributed network in accordance with the present invention. A first computing unit 100A and a second computing unit 100B may each have several applications running simultaneously. For Example, computing unit 100A may have a VoIP application 110A, which VoIP application may be sending and receiving UDP/RTP packets from a VoIP application 110B, running on computing device 100B. A video application 112A, an application sharing module 114A and any one of a number of other communication applications 116A may transmit and receive data packets or media streams from corresponding applications 112B, 114B, and 116B, running on computing device 100B.

Encapsulator/decapsulator units 120A and 120B may intercept data packets or media streams generated by communication applications running on their respective computers and may encapsulate at least a portion of one or more packets (e.g. data segments) from one or more of the sources applications into a single encapsulated multimedia packet. The encapsulator/decapsulator units 120A and 120B may send and receive encapsulated multimedia packets over a distributed network such as the Internet. The encapsulated multimedia packets'transport protocol may be TCP/IP.

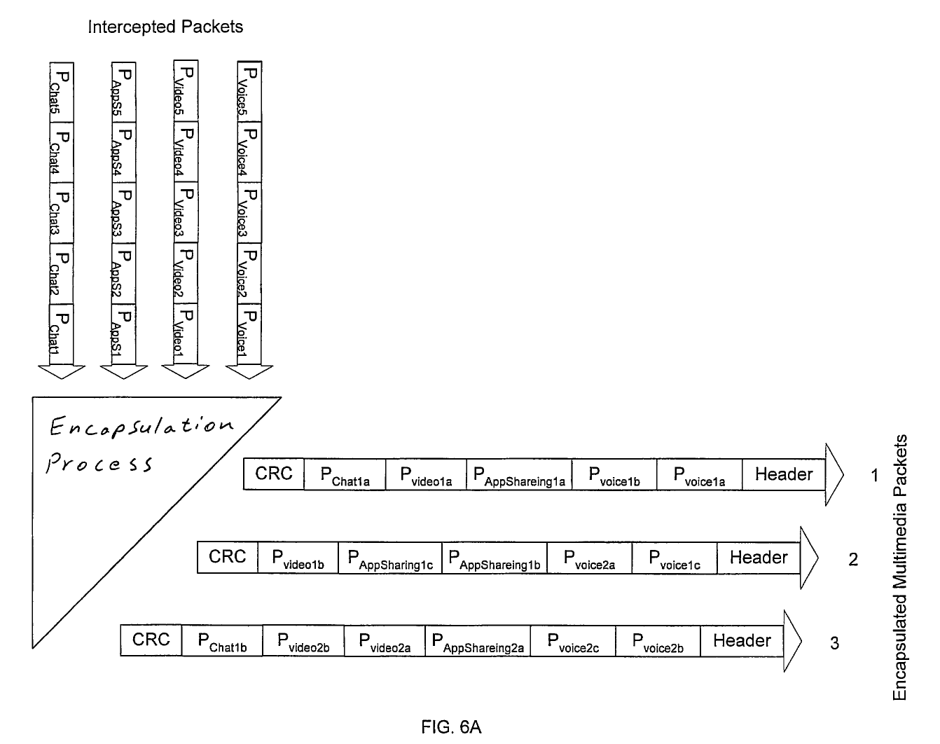

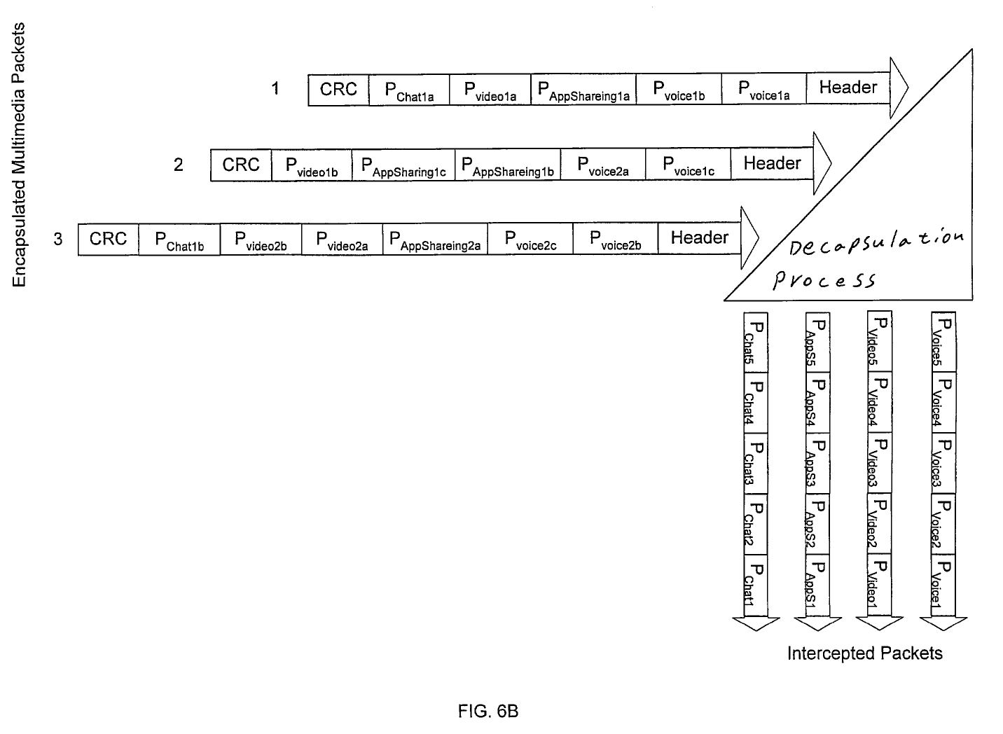

FIG. 6A shows an example of how a stream of packets generated by four separate source applications running on a computing device may be encapsulated into a series of encapsulated multimedia packets. Each encapsulated packet may contain a data segment from one or more of the packets intercepted from the source applications. The data segment may represent the entire intercepted packet or as shown in FIG. 6A may be just a portion of an intercepted packet.

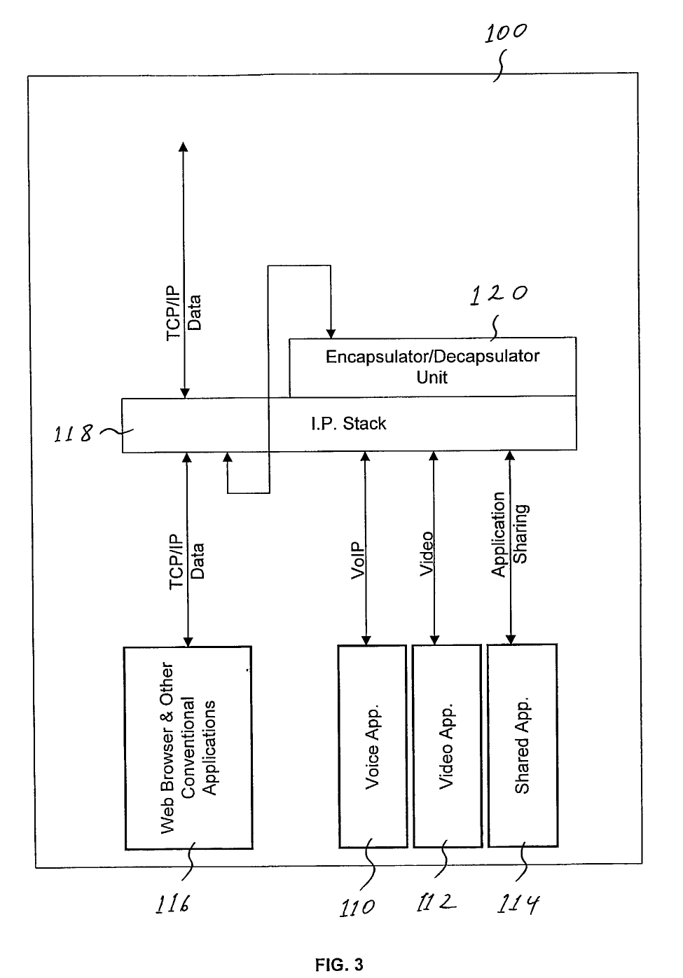

Turing back to FIG. 3, an encapsulator/decapsulator unit 120A or 120B may receive an encapsulated multimedia packet and may deconstruct or de-encapsulate the encapsulated packet into its constituent data segments. The data segments may be reconstruct into the original packets transmitted by the source applications and intercepted by the encapsulator/decapsulator unit 120A or 120B on the source computing unit 100. The reconstructed packets may be forward to the source application's corresponding application running on the receiving computing unit 100A or 100B. For example, a packet produced by VoIP application 110A may be intercepted by encapsulator/decapsulator unit 120A and at least part of the VoIP packet may be encapsulated into an encapsulated multimedia packet according to the present invention. The encapsulated multimedia packet may be sent over the Internet and received by computing unit 100B and encapsulator/decapsulator unit 120B. Encapsulator/decapsulator unit 120B may deconstruct the encapsulated packet into data constituent segments.

Once all the segments constituting the original packet have been extracted from the received encapsulated packet, the original packet may be reconstructed and sent to the packet's destination application. In some embodiments of the present invention, a data segment from a de-encapsulated or deconstructed encapsulated packet may be converted into a packet smaller than the original intercepted packet. For example, a 60 KB packet may be produced by VoIP application 110A. The VoIP packet may be parsed into two 30 KB data segments by encapsulator/decapsultor unit 120A and the first data segment may be encapsulated in a multimedia packet along with data segments from other applications simultaneously running on the computing unit 100A. Upon being received by encapsulator/decapsultor unit 120B, the multimedia packet with the first VoIP data segment may be deconstructed and the 30 KB VoIP data segment may be converted into a VoIP packet which may be sent to VoIP application 110B.

FIG. 6B shows an example of how encapsulated multimedia packets received by an encapsulator/decapsultor unit 120 may be converted back into packets which were intercepted and encapsulated by a corresponding encapsulator/decapsultor unit 120 on the computing unit 100 where the encapsulated packet was produced.

Turning back to FIG. 3, there is shown a block diagram with a computing unit having an encapsulator/decapsulator unit 120 according to the present invention. The encapsulator/decapsulator unit 120 may be an application running on the computing unit 100 and may communicate with the computing unit's network layer or I.P. stack 118. Data produced by various applications, for example VoIP 110 and Video 112, may be packed by the computing unit's I.P. stack 118. Communication between applications 110 and 112 and the I.P stack 118 may be established through a “socket” for each application. The packetizing and conventional individual transmission of data from an application on to a network is well known, and any method or system presently known or to be devised in the future is applicable to the present invention.

The encapsulator/decapsulator unit 120 may intercept packets related to the data produced by the communication applications 110 and 112. Instead of the data produced by each communication application being sent to a destination intended by the communication application, for example a corresponding application on another computing unit, the packets may be intercepted prior to being forwarded to a network. The packets may be read and data segments from each may be inserted into a data structure representing an encapsulated multimedia packet according to the present invention. The encapsulator/decapsulator unit 120 may forward the data structure representing an encapsulated multimedia packet back to the computing unit's 100 I.P. stack for packetizing and forward to a destination computing unit. As part of the encapsulated packet (See FIG. 6A), a packet header may contain information as to the nature of the data segments contained therein and what is the destination application for each of the segments, and other information relating to the reconstruction of the intercepted packets from which the data segments were taken.

Conversely, the encapsulator/decapsulator unit 120 may receive from the computing units network layer or I.P. stack 118 an encapsulated multimedia packet sent by an encapsulator/decapsulator unit 120 from another computing unit. In that event, the encapsulator/decapsulator unit 120 may convert the received encapsulated packet into its constituent data segments, packetize the data segments into packets resembling those packets which were intercepted in order to form the encapsulated packet, and forward the newly reconstructed packets to the I.P. stack. The I.P. stack may see the newly reconstructed packets as having arrived from the network.

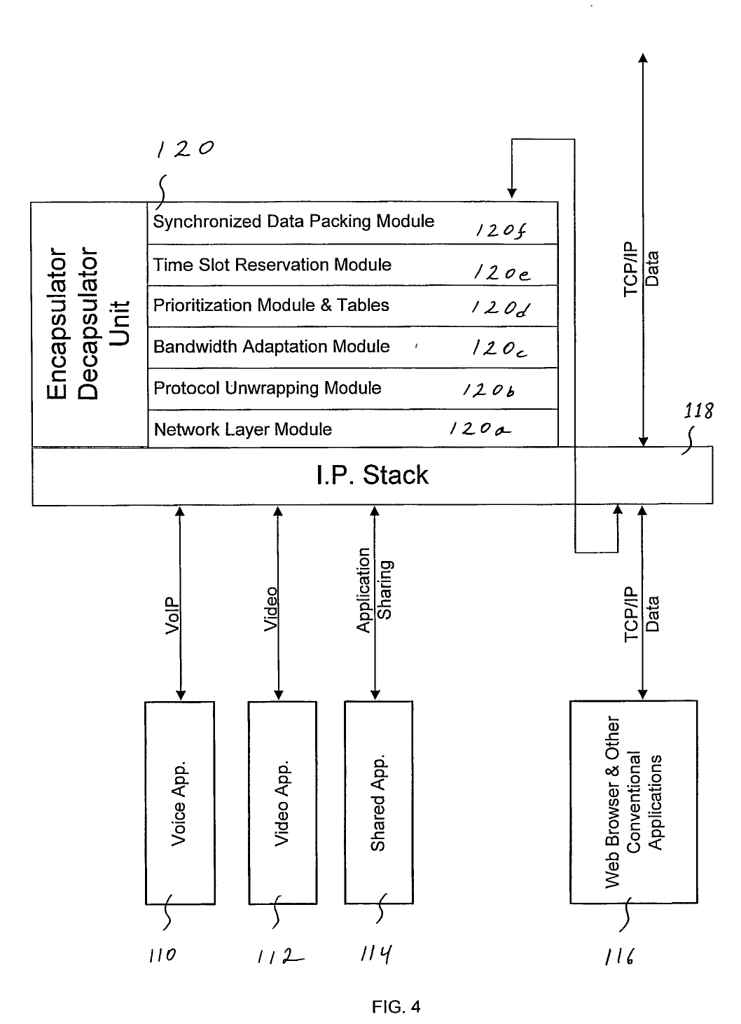

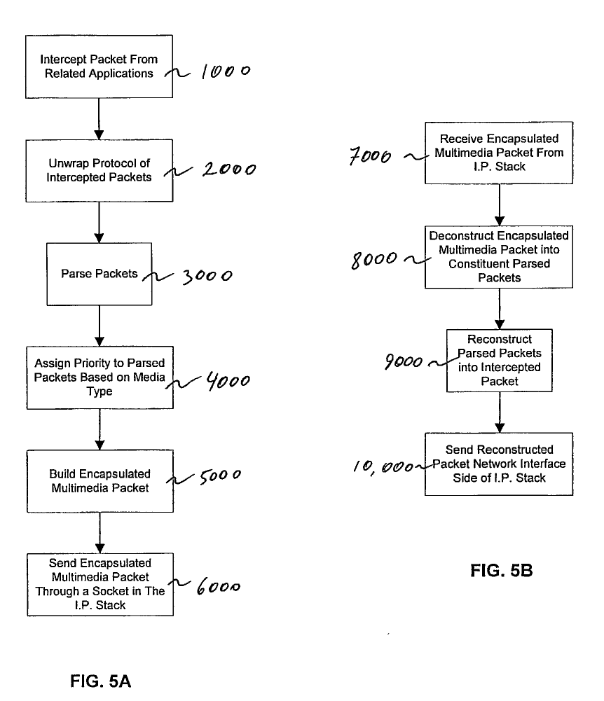

Turning now to FIG. 4, there is shown a block diagram of an encapsulator/decapsulator unit 120 according to some embodiment of the present invention. Also looking at the flow chat of FIG. 5A, it may be seen that a network layer module 120a may establish communication with the computing unit's network layer or I.P. stack 118. The network layer may request the I.P. stack to forward all packets from one or more specific source applications (e.g. VoIP 110 and Video 112) to the encapsulator/decapsulator unit 120 and not to send the packet to its designated destination (step 1000). Protocol unwrapping module 120b may unwrap the intercepted packet (step 2000), for example by removing the header and removing redundant protocol specific coding. Protocol unwrapping, that is—recovering the original source bits from a data packet, is well known. A bandwidth adaptation module 120c may parse the original source bits into smaller data segments (step 3000). The size of the data segments may be related to the available bandwidth between the source computing unit and the destination computing unit. The relationship between available bandwidth and data segment size may be a direct one, that is, the greater the available bandwidth, the larger the data segments.

Prioritization module and tables 120d may be used to apply a priority value to each intercepted packet and its associated data segments (step 4000). Priority may be based on the source application of the packet. Source applications whose performance is relatively more time critical than applications (e.g. VoIP) may be assigned a higher priority value than an application whose performance is not as time critical. Applications requiring relatively more bandwidth than applications (e.g. Application Sharing) to properly operate may also be assigned higher priority values. The rules for assigning priority values to applications and their associated data packets may vary from case to case. For example, in some situation a video application may receive the highest priority, while in other cases, where video may not be needed, the prioritization module may assign the video application the lowest priority value.

A synchronized data packing module 120f may construct an encapsulated packet as exemplified in FIGS. 6A and 6B (step 5000). The packing module may 120f may insert data segments from one ore more source applications into the encapsulated packet. A time slot reservation module 120e, or some other functionally equivalent module (e.g. bit space reservation module), may instruct the packing module as to what portion of the encapsulated packet to allocate to data segments from a specific source application. In some embodiments of the present invention, the portion allotted to data segment from a specific application may be directly related to the relative priority value of the specific source application. For example, if a VoIP application 110 has a priority value of 5 and the video application 112 has a priority value of 2, and the packing module 120f was only packing data segments from these two applications into an encapsulated packet, the VoIP data segment(s) may constitute about 5/7th of the total source bits (raw data) of the encapsulated packet.

Once the construction and packing of the source bits and header is completed by the synchronized data packing module 120f, the encapsulated data may be sent to the computing unit's I.P stack to be packetized (step 6000). In some embodiment of the present invention, the I.P. stack is instructed to packetize the encapsulated multimedia packet as a TCP/IP packet. In other embodiments the packet may be a UDP/RTP packet or of any other transport protocol know today or to be devised in the future.

Encapsulated multimedia packets received by the encapsulator/decapsulator unit 120 may undergo a reverse process from the one described directly above. Turning now to the flow chart of FIG. 5B, with continued reference to FIG. 4, the network layer module 120 may receive the encapsulated packet (step 7000), the protocol unwrapping module 120b may unwrap the encapsulated packet's protocol, and the synchronized data packing unit 120f may unpack the source bits of the encapsulated packet based on information in a header of the packet (step 8000). Data segments from the same source application may be combined as described above and packetized to resemble the intercepted packets (step 9000). The reconstructed (also referred to as newly constructed) packets may be forward to the network side of the I.P. stack 118 (step 10,000), from where they may be unwrapped and the source data forwarded to respective destination applications.

While certain features of the present invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. An encapsulator comprising;
a network layer module to communicate with a computing device's network layer and to intercept a packet containing data from a source application running on the computing device;
a protocol unwrapping unit to unwrap the intercepted packet;
a prioritization module to assign a priority value to the unwrapped packet based on the packet's source application; and
a synchronized data packing module to insert into an encapsulated packet at least a portion of the unwrapped packet, wherein the at least a portion of the unwrapped packet's size relative to the encapsulated packet's size is correlated to the inserted packet's-relative priority value.

2. The encapsulator according to claim 1, wherein said network layer module forwards the encapsulated packet to the computing device's network layer designating a transport protocol other than the intercepted packet's protocol.

3. The encapsulator according to claim 1, wherein said network layer module is adapted to intercepts and unwrapping a second packet containing data from a second source application running on the computing device and said synchronized data packing module is adapted to insert into the encapsulated packet at least a portion of the second unwrapped packet.

4. The encapsulator according to claim 1, further comprising a bandwidth adaptation module to portion an unwrapped packet into data segments.

5. The encapsulator according to claim 4, wherein said adaptation module receives information regarding bandwidth between the computing unit and a second computing device and partitions an unwrapped packet into data segments whose size is correlated to the available bandwidth.

6. The encapsulator according to claim 5, further comprising a time slot reservation module to assign a sequence to packet segments with the encapsulated packet.

7. The encapsulator according to claim 2, wherein said network layer module forwards the encapsulated packet to the computing device's network layer designating the encapsulated packet's protocol as TCP/IP packet.

8. A decapsulator comprising:
a network layer module to communicate with a computing device's network layer and to receive an encapsulated packet;
a protocol unwrapping unit to unwrap the encapsulated packet;
a synchronized data packing module to extract data segments from the encapsulated packet and to reconstruct at least a portion of another packet from related one or more related data segments; and
wherein said network layer module is adapted to forward the reconstructed packet to the computing device's network layer.

9. The decapsulator according to claim 8 wherein said synchronized data packing module reconstructs packets from data segments of the encapsulated packet based on information contained in the encapsulated packet's header.

10. A method of encapsulating a multimedia packet comprising;
intercepting from a computing device's networking layer a packet produced by a source applications running on the computing device;
unwrapping the intercepted packet;
assigning a priority value to the unwrapped packet based on the packet's source application; and
inserting into an encapsulated packet at least a portion of the unwrapped packet, wherein the at least a portion of the unwrapped packet's size relative to the encapsulated packet's size is correlated to the inserted packet's relative priority value.

11. The method according to claim 10, wherein said network layer module forwards the encapsulated packet to the computing device's network layer designating a transport protocol other than the intercepted packet's protocol.

12. The method according to claim 10, further comprising intercepting and unwrapping a second packet containing data from a second source application and inserting into the encapsulated packet at least a portion of the second unwrapped packet.

13. The method according to claim 12, further comprising partitioning an unwrapped packet into data segments.

14. The method according to claim 13, further comprising receiving information regarding bandwidth between the computing unit and a second computing device and partitioning an unwrapped packet into data segments whose size is correlated to the available bandwidth.

15. The method according to claim 10, further comprising forwarding the encapsulated packet to the computing device's network layer and designating the encapsulated packet as a TCP/IP packet.
